(19) United States
(12) Patent Application Publication
(10) Pub. No.: US 2010/0042474 A1
(43) Pub. Date: Feb. 18, 2010

(54) System for Finding, Ranking, and Rewarding Media and Services that Offer Purchasing Assistance

(76) Inventor: Mark Reginald James, Sydney (AU)

Correspondence Address: Mark James, PO Box 500, Pymble, NSW, 2073, AU

(21) Appl. No.: 12/370,592

(22) Filed: Feb. 12, 2009

Related U.S. Application Data
(60) Provisional application No. 61/050,250, filed on May 4, 2008.

(51) Int. Cl. G06Q 30/00; G06Q 10/00; G06F 17/30; G06Q 50/00

(52) U.S. Cl. 705/10; 705/14.16; 705/14.19; 705/26; 707/5; 707/E17.017; 707/E17.044

(57) ABSTRACT

A purchasing assistance search service that allows people to find media and services that can help them choose the most suitable product, where the ranking of search results depends on the aggregate helpfulness of each medium or service, as determined by feedback from people who have purchased a product after making use of one or more assisting media or services.

This feedback is also used to distribute reward payments from product makers to the cited media and services.

Purchasers are given an incentive to provide such feedback by making it a component of a rebate claim.

### CROSS-REFERENCE TO RELATED APPLICATIONS

Website rbate.com (made public May 23, 2008), including page rbate.com/consumers/find_help

The present application claims the priority benefit of U.S. provisional patent application U.S. 61/050,250, filed May 4, 2008.

U.S. provisional patent applications 61/065,245 and U.S. 61/065,244, filed Feb. 11, 2008.

U.S. Pat. No. 5,983,214.

### STATEMENT REGARDING FEDERALLY SPONSORED RESEARCH OR DEVELOPMENT

Not applicable.

### BACKGROUND OF THE INVENTION

The present invention relates first to search engines that allow a user to find one or more sources of assistance that can help them select a product that best meets their needs or wants, where the sources presented to the user are ranked based on the degree of match between the user's query and the attributes of each source, as well as information about the relative quality of each source, as derived from collaborative feedback.

U.S. Pat. No. 5,983,214 teaches general search engines where search results are ranked using such a combination of match and collaborative data.

A deficiency of such systems is that when few barriers to providing collaborative feedback are imposed, the quality measure of a source can easily be manipulated and influenced by both stakeholders and people who provide low-quality feedback, while people in a position to provide high-quality feedback do not have an incentive to do so. Together these reduce the quality of the search engine service.

Also, such systems do not allow the user to explicitly state specific preferences and restrictions that are appropriate for a search engine that is dedicated finding suitable sources of purchasing assistance for its users.

The present invention also concerned with ways to reward assistance sources that a product purchaser has found helpful. Consumers want high-quality, unbiased professional advice and assistance at no or low cost, preferably in the form of personal service. However existing methods of funding these media and services are increasingly unable to meet this goal:

Information and advice delivered in advertising is not unbiased, and the prominence of an advertisement is at best only weakly related to its utility.

Advertising-supported media do not give consumers personal service, and the presence of advertisements reduces the clarity of presentation. There is also pressure for bias where such media make direct deals with product makers, distributors, and vendors. Furthermore, consumers are increasingly blocking, ignoring, discounting, and bypassing such ads, which is causing advertising revenue to steadily dwindle. Attempts to stem this decline by increasing the level of advertising only further burdens consumers, and accelerates the long-term trend.

Another source of income for online media are affiliate payments that they receive from vendors and price-comparison services. Such a payment is made when (1), a consumer clicks on a hyperlink that is associated with that media, which redirects the consumer to a particular a vendor or service, and (2), the consumer purchases a product at this vendor or through this service. However, even if a product purchaser found a medium that helped them decide on that purchase, the purchaser will often make their purchase without using that medium's affiliate link, which denies a reward to the creator of that medium. Another medium that provided less help can be the sole reward recipient if that medium was the final source of assistance that the consumer visited before deciding to make a purchase. Such affiliate rewards are also dependent on the honesty of vendors in reporting the click.

Moreover, the presence of affiliate links can damage the trustworthiness of the information that the media offers. Affiliate relationships are rarely disclosed, so the consumer often does not know that the owner of the medium stands to gain if the consumer purchases a particular product, which gives the medium a disincentive to give a product a bad review. Also, a medium must either be cluttered with affiliate links, or it must given consumers a limited choice of vendors.

A further source of professional purchasing advice are brokers such as mortgage, insurance, and travel brokers, that offer consumers advice, and which receive a payment from the makers or distributors of products that consumers buy through them. Like affiliate links, help brokers are not rewarded when a consumer makes a purchase elsewhere. And again like affiliate links, the broker can be the sole reward recipient even when a consumer consulted other helpful advice sources.

Brokers are also potentially compromised by their need to have a direct relationship with product makers, coupled with the fact that they will usually only recommend products from makers with which they have a fee arrangement.

Both these pressures are also felt by full-service retailers. Further, such retailers use product sales to fund the advice their staff gives consumers. But tight retail margins due to competition from discount and online outlets is increasingly limiting the quality of advice that a retailer can afford to offer.

Consumers can also explicitly pay for advice by using subscription media or fee-for-service consultants. Subscription services force consumers to pay for information that is of no use to them, while the consumer must pay a consultant even if their assistance was not helpful, making it expensive to consult more than one.

Finally, consumers can receive purchasing assistance from other consumers. Such non-professional advice is however often unreliable and poorly expressed. But consumer-written reviews are able to provide helpful feedback about how a product works in practice, and after extensive use. A single review of this type is however highly subjective, but it is hard work for a potential purchaser to digest a large number of such reviews in order to make a fair assessment. Consumers would find it very helpful if a professional found it worthwhile to edit these reviews into a brief summary of consumer experiences, and to integrate this into their professional product assessments.

This touches on another deficiency in the current state of professional purchasing assistance: Although highly-informative works could be created if product assessment professionals collaborated, this rarely happens due to the burden of having to make deals that set a fair price for the use of another's work. It would be desirable if source material could be automatically appropriately rewarded when derivative material earns income.

### BRIEF SUMMARY OF THE INVENTION

A search engine system is disclosed that makes it easier for consumers to find media and services that can provide them with high-quality purchasing assistance, and a method and system is disclosed that improves the way that such media and services are rewarded for providing such purchasing assistance.

The disclosed search engine (a), allows a consumer to specify the types of purchasing assistance that they are seeking, (b), only returns search results that provide information about media and services that offer purchasing assistance, (c), provides an incentive for consumers who have purchased a product to provide feedback about the helpfulness of each medium or service they made use of, and (d), makes aggregate use of this feedback to calculate a difficult-to-corrupt measure of the quality of a medium or service, which the system makes use of when ranking search results.

The disclosed reward system (a), accepts feedback from product purchasers concerning the helpfulness of one or more media and services that they have made use of prior to a particular purchase, (b), provides purchasers with an incentive to provide such feedback by offering them a rebate or reward from the maker or distributor of the purchased product, and by requesting such feedback during a claim for this rebate or reward, (c), provides an easy way for purchasers to recall and specify which providers they found helpful, (d), uses such purchaser feedback to divide a reward for such purchasing assistance that has been offered by the maker or distributor of the purchased product, (e), allows providers of purchasing assistance to view selected details of such offers, and (f), allows product makers or distributors to view statistics about competitive offers made by other product makers or distributors, as well as information about consumer use of purchasing assistants.

### DETAILED DESCRIPTION OF THE INVENTION

The term “help entity” will be used to describe any medium or service that offers assistance to consumers (persons or businesses) who are looking to fulfill a want or need. A help entity is able to provide advice about particular wants and needs, and the extent to which use of or purchase of a particular product (a good or service) would fulfill those wants and needs. An help entity can also be a service that chooses and purchases products on behalf of a consumer.

A help entity may provide product information, evaluations, recommendations, demonstrations, and trials. Help entity media may include text, images, sound, and video. Services may be provided over the Internet, using a telephone, at the consumer's premises, or at the premises of the service provider. A full-service retailer can qualify as a help entity.

The present invention is embodied by one or more computer servers (“a” in FIG. 1 on page 14) that maintain an index of information about, attributes of, and contact details for, help entities (“e” and “b” in FIG. 1), that can be searched by consumers (“c” in FIG. 1). Such a purchasing assistance search service will be termed a PASS. The indexed attributes can include the names of brands and products with which the entity deals.

Each indexed entity is also associated with an attribute that provides an aggregate measure of how helpful that entity has been to product purchasers.

Organizations that create or control help entities (“helpers”, “d” in FIG. 1) can register their entities with the PASS (“e” and “f” in FIG. 1). Such registered help entities are assigned a unique code (“g” in FIG. 1). Help entities can also be added to the PASS through manual or automatic indexing of either public information or information requested from helpers.

Consumers use the PASS by providing one or more search terms, restrictions, or preferences (“h” in FIG. 1). The server may automatically add a restriction or preference based on information obtained about the searcher.

A restriction or preference can include:
1. The user's location,
2. A product category associated with either a product the consumer wishes to purchase, or the field in which returned entities should provide assistance,
3. The type of medium that is sought: a review of a single product, a comparative review, a buyers' guide or commentary, a digest of other reviews, a review of a product bundle, an automated purchase advisor, product information, a media group (website, periodical, channel), price and availability information, etc.,
4. Whether returned media should be expert level or novice level,
5. The type of service that is sought: information & recommendations, demonstrations & test-drives, samples & trials, a purchasing service, etc.,
6. The method by which a service is delivered: Over the Internet, by phone, by mail, at the consumer's premises, at the helper's premises, etc.,
7. Whether returned media and services should be free-of-charge or not free-of-charge, and
8. Whether returned services should have or should not have an associated sales service.

A subset of entities that match the supplied criteria are displayed or otherwise made available to the user (“i” in FIG. 1). The identity of the entities returned to the user, or the sequence in which entities are presented to the user, is determined by a ranking algorithm that takes into account the degree of match between the attributes of an entity and the user's terms, restrictions, and preferences, as well as an entity's aggregate helpfulness attribute, as derived from purchaser feedback.

The disclosed invention provides two ways to make it easier for a purchaser to recall and identify which registered help entities they consulted (“j” in FIG. 1) and received assistance from (“k” in FIG. 1) prior to a particular purchase, and found helpful, whether or not they made use of the PASS to connect with that entity.

First, helpers can make the unique code that has been assigned to an entity known to the users of that entity (“l” in FIG. 1). Codes may be displayed in articles, magazines, webpages, video presentations, invoices, premises, business cards, or text messages, or can be spoken in an audio communication. Each registered entity in PASS search results (“i” in FIG. 1) is also labeled with its code.

Second, the server allows registered entities that have an associated online presence to place a button on that webpage that a consumer may press to add that entity to a list of entity bookmarks that they maintain in an account that they hold with the disclosed server (“m” and “n” in FIG. 1). For consumers that already hold such an account, this can be done without the consumer leaving the entity's page. A consumer can also opt to have this button automatically activated when they visit pages containing such a button.

Third, helpers may themselves add their entities to the bookmarks of consumers that use those entities, by providing the server with a combination of an entity code and a unique consumer identifier, such as an email address (“o” in FIG. 1).

Businesses that make, distribute, or sell products (“makers”, “p” in FIG. 1) are able to register with the disclosed server. These makers are able to register cash rebates that they wish to pay to people who purchase certain quantities of certain products in certain regions (“q” in FIG. 1). The server allows makers to order quantities of unique codes (“claim codes”) that are each associated with a single purchase and rebate (“r” in FIG. 1). The maker makes funds available to the server that cover both consumer rebates and helper rewards (see below) (“s” in FIG. 1).

When a purchaser (“t” in FIG. 1) is entitled to a rebate for their purchase, the maker provides that purchaser with one of these unique codes, either after making contact with the purchaser and determining their eligibility (“u” and “v” in FIG. 1), or by supplying the code with the product or service, possibly through a vendor (“w”, “x”, and “y” in FIG. 1). The invented system can facilitate this latter method by offering to supply makers with labels that each contain a (perhaps concealed) claim code.

Purchasers who receive a code are directed to make their rebate claim by entering that code a website associated with the disclosed server (“z” in FIG. 1). Purchasers are asked to delay making their claim until they have made some use of the product they have purchased. This allows the purchaser to decide how satisfied they are with their purchase when making their claim.

Part of the claim process asks the claimer to provide (cite) a list of help entities that they consulted prior to their purchase, and found helpful (“1” in FIG. 1). Registered entities can be cited by either entering the entity's unique code, or by selecting that entity from a list of the consumer's entity bookmarks (if any). The list of entity bookmarks is filtered to remove entities that operate in product categories unrelated to the product that has been purchased (“2” in FIG. 1).

The rebate claimer can also state that they made use of one or more sources of purchasing assistance that are not registered with the server. This can be done by appending a number of general entity types to the displayed bookmark list. For example, “help entity without code”, “informal advice”, “private advice”, and “self-help”. Unregistered entities can also be separately identified by name or Internet URI.

A rebate claimer is able to cite more than one entity on a given claim, and is also able to distinguish the degree of helpfulness of each entity. For example, “very helpful” or “helpful”.

Claimers are given an option during the claim to donate part or all of their rebate to helpers they cite. This gives helpers an income source that does not come directly from a party who has something to gain by making such payments, and so is associated with a reduced conflict of interest. Consumers can also be informed of a way, or given a means, of making separate donations from their own funds (“3” in FIG. 1).

After the purchaser has completed any other tasks associated with the claim (for example, answering survey questions supplied to the server by makers), the server schedules payment of the rebate to the purchaser from funds made available by the maker of the purchased product, less any part of the rebate that has been donated to helpers (“s” and “4” in FIG. 1). Alternatively, the server may send purchaser details to the maker, who themselves pays the rebate to the purchaser).

The server calculates an amount of citation credit earned by each cited entity, where a fixed amount of citation credit for each claim is divided among those entities, taking into account the total number of registered and unregistered entities cited, and the helpfulness degree of each.

The server maintains an aggregate citation credit number that has been earned by each registered entity (“5” in FIG. 1). Aggregated citation credit can also be stored for identified unregistered entities.

For each of their entities a helper may also register, and nominate a contribution fraction for, one or more entities that are controlled by other helpers, and which collaborate with, or have collaborated with, the first helper in the operation or creation of the original entity (“6” in FIG. 1). The appropriate portion of citation credit earned by the original entity is reallocated to these contributing entities, and this flow of credit can continue through many levels of collaboration. This method of reward distribution gives helpers an incentive to cooperate, producing higher quality work that is more useful to consumers. Review digests for example.

The server can provide information to makers about consumer use of helpers (“7” in FIG. 1). Such information can include the entities that have the highest citation credit, the entities that have the greatest number of bookmarks, and the entities that have been most visited by PASS users for a given product.

The server makes use of aggregate citation credit when ranking entities returned by the PASS, altering the ranking that results from a PASS user's terms, preferences, and restrictions, raising the ranking of entities with higher levels of citation credit relative to those with lower levels.

Such a method of determining entity rankings makes it difficult for entities or other parties to inappropriately manipulate their rankings, because the citation credit of an entity is only changed when a product is purchased, and is only changed by a limited amount for each purchase.

A method is also disclosed for automatically optimizing the relative weightings of the different factors that contribute to the overall ranking of an entity on a search, so that the entities that have the highest overall ranking are those most likely to be the most helpful to the searcher—an improvement on using fixed estimates for the factor weights.

The degree of match between an entity, and a user's search terms, preferences, and restrictions, without considering the travel distance between a service entity and the user, is a multi-variable function that generates a “terms score” for that entity. Further, some non-decreasing function of the distance between the entity and the user generates a “distance score”, where a neutral distance score is used for entities without a location, or with an unknown location. Finally a “credit score” is generated as some non-decreasing function of the entity's aggregate citation credit. These three scores are multiplied to yield a total score for that entity on that search, which determines the rank of entities returned to the user. The relative weighting of the three score components in the final score depends on the nature of the three functions used to calculate each score component.

Automatic optimization of these weights is achieved by storing a unique user identifier, the user's search terms (possibly including a user's location), and the unique code of a registered entity whenever a PASS user selects an entity from a provided selection. Such selection may involve the user either requesting to receive that entity's details, or when the PASS connects the user to the entity via hyperlink or telephone. The unique user identifier can be created when the user registers with the PASS, and is associated with a user name, Web browser, or telephone number.

When one of these registered PASS users subsequently makes contact with the PASS to enter their help entity citations following a purchase, the search terms the user provided to the PASS to find a cited entity can be retrieved if such a search was conducted for that entity. These searches can be re-run, and the parameter values used to calculate of each component (term, distance, and credit) of the search score of each of these entities, as well the set of search score parameter values for the entity that was ranked highest in the search, noted. Instead of obtaining these parameter values by re-running the search, they can instead be stored as part of the search information. This method would however base weighting changes on their values at the time of search, rather than their values at the time of adjustment.

For each entity the weight of the credit score component is adjusted by an amount equal to an adjustment constant multiplied by the helpfulness value the purchaser has assigned to the entity, multiplied by a value whose sign results in the adjustment decreasing the difference between the search score of the cited entity and the search score of the top-ranked entity for that search. A separate similar adjustment can be made to the weight of the distance score component; or instead an adjustment of the two weights that jointly decreases the score difference can be made.

After being used to update the search weights, the information stored about the user's search selections can be deleted, or an aging weight applied.

One algorithmic embodiment of the above procedure follows:

Let the search score s for search terms t, user u, and entity e be calculated as the product of term score, distance score, and credit score terms:

s(t,u,e,K_{d},K_{c})=sₜ(e,t)·s_{d}(d(u,e),K_{d})·s_{c}(c(e),K_{c})

where d retrieves the distance between the locations of its parameters (or a neutral distance value if one of these is unknown), and c returns either an entity's total citation credit or a non-linear function of this credit. If entity credit has been broken down by product category or market, c can also take t as a parameter.

The distance and credit score functions are respectively parameterized by K_{d} and K_{c} such that larger values of these parameters increase the range and discrimination of their respective functions. An example of a suitable form for the distance and credit score functions is

$${s}_{x} ( x , K ) = \frac{1 + Kx}{1 + {Kx}_{m ax}} .$$

Given that user U requested information about entity e_{c} after search t, for which search the entity with the highest search score was e₁, and that user u subsequently cited entity e_{c} as having helpfulness level h, then unless e_{c} and e₁ are the same entity, the aim is to adjust parameters K_{d} and K_{c} so that the search score ratio e_{c}:e₁ is increased when h is positive, making it more likely that users that supply the PASS with terms similar to t, particularly those located near u, can find or be supplied with helpful entity e_{c}.

Defining the search score ratio r as

$$r ≡ \frac{s ( t , u , {e}_{c} , {K}_{d} , {K}_{c} )}{s ( t , u , {e}_{1} , {K}_{d} , {K}_{c} )} ,$$

and opting to increase r by a fixed amount Δr per unit h, application of a simple gradient ascent method is one way to make suitable changes in K_{d} and K_{c}:

$$Δ {K}_{d} = \frac{Δ r \cdot h}{\partial r / \partial {K}_{d}} and Δ {K}_{c} = \frac{Δ r \cdot h}{\partial r / \partial {K}_{c}} .$$

If parameter values are known, the partial derivatives can be easily calculated. More accurate adjustments can be made by using Newton's Method to jointly change K_{d} and K_{c}.

If a non-linear change in r is desired, narrowing wide differences between the top score and the score of the cited entity faster than narrow differences, then a fixed change can instead be sought in a non-linear function of the score ratio, such as r raised to a power greater than 1.

Adjustments in K_{d} and K_{c} should be small so that the optimal component weightings, averaged over all citations, can be approached. Rather than adjusting one set of component weightings, the search space can instead be divided into areas, with weightings independently optimized for each area.

A second major aspect of the disclosed invention is a method and system for rewarding providers of purchasing assistance when they help a product purchaser.

In addition to registering rebate offers, makers can register one or more helper cash bonus offers with the server, and make funds available to pay these bonuses (“q”, “s”, and “8” in FIG. 1). Each offer is for a cash bonus that can be divided among the helpers that are associated with the registered entities that were cited by a person who has claimed a rebate on a product made or sold by that maker. This allows makers to encourage helpers to work with their products, and to support helpers who assist their customers.

The proportion of the cash bonus to which a helper associated with a particular cited entity is entitled is equal to the fraction of the citation credit earned by that entity on that claim. If non-registered entities have been cited, the maker is charged less than the full amount of their bonus offer.

The server enforces a minimum bonus offer for each product category or product market (a combination of product category and product availability region), ensuring that helpers can earn a reasonable and appropriate bonus for the nature of their work.

Makers are able to view statistics of bonus offers made by other makers for products in the same market, allowing them to make their offers competitive (“9” in FIG. 1).

Rather than being paid their entitled share of the bonus for a particular product, a helper may instead choose to receive the equivalent share of the minimum bonus offer made over the set of all products in the same market as that product. They may do this if they wish to reduce their actual and perceived conflict of interest by receiving the same reward, no matter which product in that market was purchased after a consumer consulted one of their entities.

Helpers may also choose to receive no bonus payments, only citation credit.

Helpers can opt to view a list of bonus offers available in particular product markets, allowing them to respond by adjusting the focus of their work (“0” in FIG. 1). The size of bonus offer pools can also be displayed, which each represents the bonus amount multiplied by the number of unclaimed claim codes for that product. The total amount that has already been paid to helpers through this bonus offer can also be displayed. This allows helpers to assess the extent to which the maker has supported the offer by distributing claim codes that offer both rebates and the prospect of citations and rewards.

Helpers are given the option to hide amounts in bonus lists, seeing only a list of products for which bonuses are available. They can also choose to see aggregate offer data for particular product markets, rather than individual offers. Each of these assist helpers in dealing with the actual and perceived conflict of interest that the viewing of bonus offers presents.

These choices that helpers make and register with the server regarding the visibility and payment of bonus offers are able to be viewed by PASS users, accompanied by an optional statement in which helpers can explain their choices and their other editorial policies (“f” and “i” in FIG. 1). This allows consumers to make an assessment as to whether a helper is likely to work in their best interests.

After a rebate claim has been submitted, the server schedules payment of bonus offer shares to helpers, along with any donations that the purchaser has made to helpers (“$” in FIG. 1).

The net effect of bonus and donation payments is that helpers are given an income stream where
1. More than one helper can be rewarded for providing assistance related to a single purchase,
2. Assistance can be rewarded without requiring that the assistance be reported to the vendor that sold the product to the consumer, and without requiring that the vendor report the assistance to an affiliate tallying system,
3. The rewarded entities need not be associated with the online environment, where affiliate relationships are easily signaled through links, nor directly associated with makers, as is the case for help brokers,
4. A helper can be rewarded even if they advise a consumer against purchasing a particular product, namely when a consumer cites an entity of that helper after purchasing a different product that carries a rebate or bonus, and
5. A maker paying a a bonus to a helper can be sure that a purchaser of one of their products has found an entity of that helper useful, rather than that entity simply being the source of a recent affiliate redirection.

The combination of the bonus and donation income streams can help make viable a wide variety of free purchasing assistants, which consumers can find using the PASS, including free advice provided over the phone.

### DRAWINGS

FIG. 1 follows on page 14.

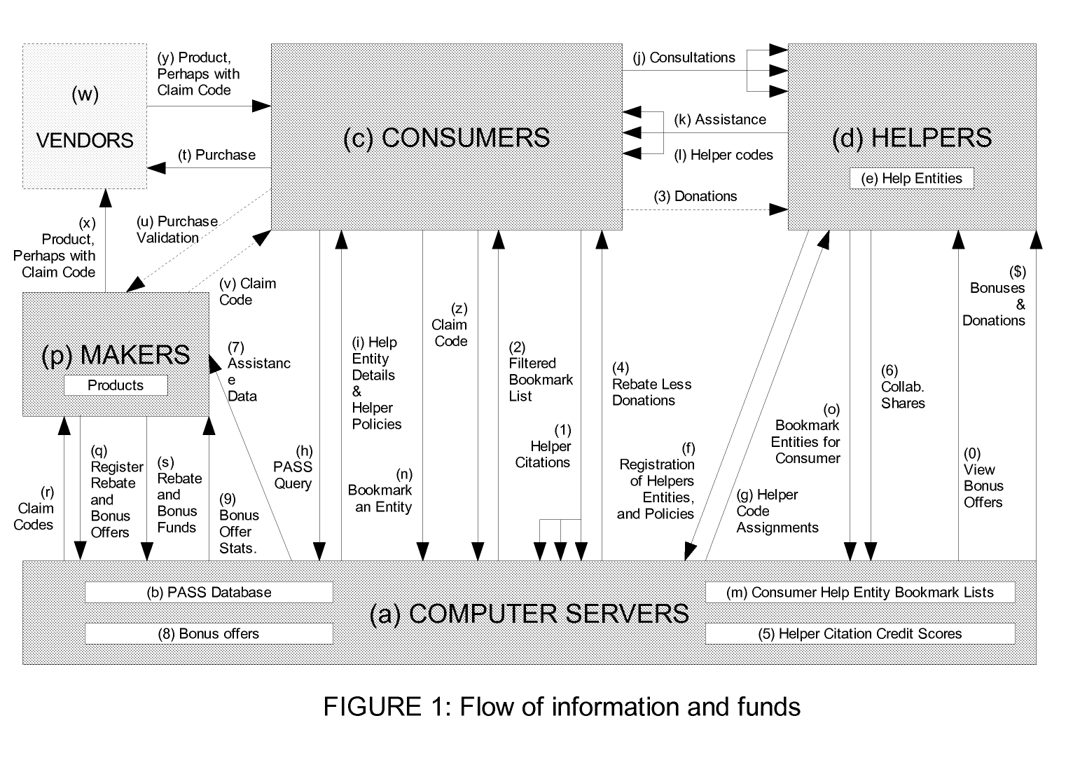

1. A system that:
(a) maintains an index of the details of media and services that are able to provide people with information or advice about products that would best meet their wants or needs, as well as services that can purchase products on the person's behalf,
(b) makes it possible for people to search that index to obtain information about, contact details for, or contact channels to, these media and services, and that
(c) uses an aggregate measure of the helpfulness of each medium or service to help determine the sequence or identity of the media and services presented to the searcher, where a component of said ranking measure is derived from feedback provided by people who have purchased a product after making use of one or more of these media or services.

2. The system of claim 1 where the ranking measure takes into account the degree of match between the attributes of the medium or service and one or more search terms, restrictions, and preferences, either provided to the system by the person, or automatically determined about the person by the system.

3. The system of claim 2 where the relative weightings of one or more factors that influence rankings are automatically adjusted by re-running the searches of users who have provided feedback about a particular medium of service, examining the size of each ranking factor for that medium or service in that re-run search result, and by subsequently adjusting factor weightings in a way that increases the ranking of that result in that search when the feedback was complementary, and that decreases the ranking of that result in that search when the feedback was adverse.

4. The system of claim 2 where a restriction or preference can include
(a), the person's location,
(b), the product category of a desired product,
(c), the product category in which a returned medium or service should provide assistance,
(d), the level of category knowledge required to comprehend returned media,
(e), the cost to the person of using that medium or service,
(f), whether a service does or does not sell products,
(g), the means by which a service is delivered to its users, or
(h), the type of media or type of service that is being offered.

5. The system of claim 2 where attributes of the medium or service include the names of brands and products with which the medium or service deals with.

6. The system of claim 1 where information about purchaser use of media and services is provided to the makers, distributors, or vendors of the purchased products.

7. A system that offers a provider of purchasing assistance (“a helper”) a reward when a product purchaser informs the system that a medium or service supplied by this provider contributed to their decision to buy a particular product, where some part of the cost of the reward is borne by the maker, distributor, or vendor (“the maker”) of the product that was purchased.

8. The system of claim 7 where a purchaser can cite a multiplicity of helpers in relation to a single purchase.

9. The system of claim 8 where each cited helper's share of the reward is influenced by the level of helpfulness with which the purchaser attributes to them.

10. The system of claim 7 where the system redirects a portion of a helper's reward to other helpers that collaborated with the first helper on the cited medium or service.

11. The system of claim 7 where the purchaser bears some or all the cost of the reward themselves, as donated or otherwise deducted from a cash rebate or other reward provided to the purchaser by the maker.

12. The system of claim 7 where reward offers are made by makers, and where rewards are promised to cited helpers when certain quantities of certain products are purchased.

13. The system of claim 12 where the system enforces a minimum reward offer for each product category or product market (a combination of product category and product availability).

14. The system of claim 12 where helpers can opt to receive a share of the lowest-value offer made by makers, taken over all products in the purchased product's market, rather than a share of the specific offer available for the purchased product.

15. The system of claim 12 where helpers can opt to receive no reward.

16. The system of claim 12 where offers can be viewed by helpers in a way that displays the product, the offer amount, and the required purchase quantity.

17. The system of claim 12 where offers can be viewed by helpers in a way that displays the product and the required purchase quantity, but offer amount are hidden.

18. The system of claim 12 where helpers can view aggregate offer data about particular product markets, but not about individual products.

19. The system of claim 12 where helpers can view information about the total rewards a particular maker has both paid and has committed to pay in relation to a particular offer.

20. The system of claim 12 where makers are able to view statistics concerning the set of offers that have been made for products associated with particular combinations of category and availability region.

21. The systems of claim 1 or claim 7 where a purchaser is given an incentive to provide the helpfulness feedback to the system by making the provision of such feedback a component of a claim for a cash rebate or other reward whose cost is borne by the maker, distributor, or vendor of the purchased product.

22. The systems of claim 1 or claim 7 whereby a purchaser can identify a medium or service that they found helpful by either
(a), citing a unique code that has been assigned to the medium or service by the system, which is made known to the purchaser by either the system or the medium or service itself, or
(b) selecting that medium or service from a list, where each medium or service on the list has either been manually added by either the purchaser or the helper, or has been automatically added by the system when either the purchaser made use of that medium or service, or when the purchaser selected the medium or service during their use of the system, and where the system filters the list to remove media and services that are not relevant to the product being claimed.
